(19) United States
(12) Patent Application Publication
(10) Pub. No.: US 2025/0210870 A1
(43) Pub. Date: Jun. 26, 2025

(54) UNITARY STRUCTURE LENS ANTENNA

(71) Applicant: The United States of America as represented by the Secretary of the Navy, San Diego, CA (US)

(72) Inventors: Dennis Bermeo, San Diego, CA (US); Ryan Anderson, San Diego, CA (US); Kemakeo Wilson, San Diego, CA (US); Patrick Groves, San Diego, CA (US)

(73) Assignee: The United States of America as represented by the Secretary of the Navy, San Diego, CA (US)

(21) Appl. No.: 18/394,487

(22) Filed: Dec. 22, 2023

(51) Int. Cl. H01Q 13/08; B29D 11/00; B33Y 10/00; B33Y 70/00; B33Y 80/00; H01Q 13/04

(52) U.S. Cl. CPC H01Q 13/08; B29D 11/00817; B29D 11/00865; B33Y 70/00; B33Y 80/00; H01Q 13/04; B29K 2995/0006; B33Y 10/00

(57) ABSTRACT

A unitary structure lens antenna apparatus and a method for producing a unitary lens antenna. A unitary lens antenna comprises a radiofrequency (RF) cable having an inner conductor and an outer conductor; and a cylindrical lens having a biconical antenna cavity and a lens feed electrically coupled to the inner conductor, the lens further comprising: a top surface defining one cone of the biconical antenna cavity, having a first metalized coating and a first non-metalized cable interface with the outer conductor; a bottom surface defining another cone of the biconical antenna cavity, having a second metalized coating and a second non-metalized cable interface with the outer conductor; and a lens feed extending along a centerline of the cylindrical lens body operable to feed the RF cable through the lens.

### STATEMENT REGARDING FEDERALLY-SPONSORED RESEARCH AND DEVELOPMENT

The United States Government has ownership rights in this invention. Licensing inquiries may be directed to Office of Research and Technical Applications Naval Information Warfare Center Pacific, Code 72120, San Diego, CA, 92152; telephone (619) 553-5118; email: niwc_patent.fct@us.navy.mil, referencing Navy Case 210,783.

### BACKGROUND

Biconical antennas are broadband antennas that are typically made up of two roughly conical conductive objects that are nearly touching at their points. These antennas have dipole like characteristics, with a wider bandwidth achieved due to the double cone elements structure and typically have an omnidirectional radiation pattern in the H-plane. Biconical antennas are also referred to as “bowtie” or “butterfly” antennas. These example typically comprise wire-frame geometries or at least two roughly conical conductive objects. As such, biconical antennas consistent of many components with complex geometries. There is a need for streamlined structure for biconical antennas to improve manufacturing, scale designs, and decrease costs.

### SUMMARY

According to illustrative embodiments, a unitary lens antenna comprising a radiofrequency (RF) cable having an inner conductor and an outer conductor; and a cylindrical lens having a biconical antenna cavity and a lens feed electrically coupled to the inner conductor, the lens further comprising: atop surface defining one cone of the biconical antenna cavity, having a first metalized coating and a first non-metalized cable interface with the outer conductor; a bottom surface defining another cone of the biconical antenna cavity, having a second metalized coating and a second non-metalized cable interface with the outer conductor; and a lens feed extending along a centerline of the cylindrical lens body operable to feed the RF cable through the lens.

Additionally, A method for producing a unitary lens antenna, obtained by the process of determining a feed gap; printing, utilizing three dimensional printing techniques, a cylindrical lens having a biconical antenna cavity and a lens feed electrically coupled to the inner conductor, the lens further comprising a top surface defining one cone of a biconical antenna, having metalized coating and a non-metalized cable interface with the outer conductor; a bottom surface defining another cone of a biconical antenna, having metalized coating and a second non-metalized interface with the outer conductor, wherein the top and bottom surface are separated by the feed gap; a lens feed extending along a centerline of the cylindrical lens body operable to feed a radiofrequency (RF) cable through the lens; masking the cable interface are between the cylindrical lens and the RF cable, wherein the cable interface is located adjacent to the lens feed; metalizing the top surface and the bottom surface with a spray aerosol; inserting the RF cable, having an inner conductor and an outer conductor, into the lens feed; and coupling the RF cable to the cylindrical lens body.

It is an object to provide a Unitary Structure Lens Antenna that offers numerous benefits, including having a readily scalable design, spray-capable top and bottom surface, and a unitary structure.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The accompanying drawings, which are incorporated in and form a part of the specification, illustrate example embodiments and, together with the description, serve to explain the principles of the invention. Throughout the several views, like elements are referenced using like references. The elements in the figures are not drawn to scale and some dimensions are exaggerated for clarity. In the drawings:

FIG. 1 shows an exemplary unitary lens antenna comprising a radiofrequency (RF) cable 120, a cylindrical lens, and atop surface.

FIG. 2A shows an exemplary wireframe model of a cylindrical lens comprising a biconical antenna cavity.

FIG. 2B shows an exemplary wireframe model of cylindrical lens comprising a biconical antenna cavity and a radiofrequency cable.

FIG. 3A shows an exemplary illustration a top surface of a unitary lens antenna.

FIG. 3B shows an exemplary illustration a bottom surface of a unitary lens antenna.

FIG. 4A graphically illustrates antenna return loss of one embodiment of a unitary lens antenna.

FIG. 4B graphically illustrates Azimuth Beam Peak (dBi) (Frequency vs. Antenna Gain) of one embodiment of a unitary lens antenna.

FIG. 4C graphically illustrates Maximum Elevation Beam Peak (dBi) of one embodiment of a unitary lens antenna.

FIG. 5 shows an exemplary block-diagram of a method for producing a unitary lens antenna.

### DETAILED DESCRIPTION OF EMBODIMENTS

The disclosed apparatus and product-by-process below may be described generally, as well as in terms of specific examples and/or specific embodiments. For instances where references are made to detailed examples and/or embodiments, it should be appreciated that any of the underlying principles described are not to be limited to a single embodiment, but may be expanded for use with any of the other apparatus and product-by-process described herein as will be understood by one of ordinary skill in the art unless otherwise stated specifically.

References in the present disclosure to “one embodiment,” “an embodiment,” or any variation thereof, means that a particular element, feature, structure, or characteristic described in connection with the embodiments is included in at least one embodiment. The appearances of the phrases “in one embodiment,” “in some embodiments,” and “in other embodiments” in various places in the present disclosure are not necessarily all referring to the same embodiment or the same set of embodiments.

As used herein, the terms “comprises,” “comprising,” “includes,” “including,” “has,” “having,” or any variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of words such as “the,” “a,” or “an” are employed to describe elements and components of the embodiments herein; this is done merely for grammatical reasons and to conform to idiomatic English. This detailed description should be read to include one or at least one, and the singular also includes the plural unless it is clearly indicated otherwise.

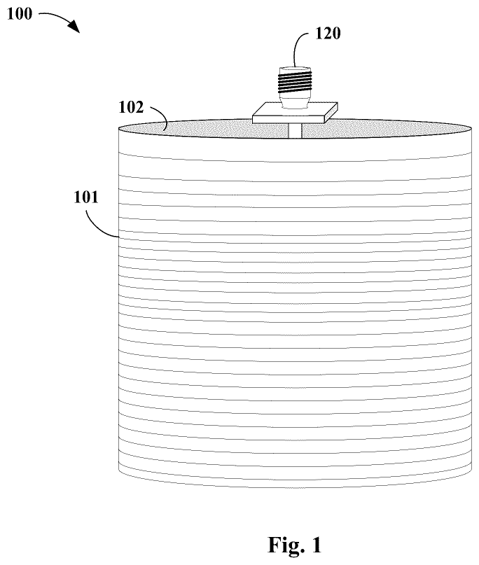

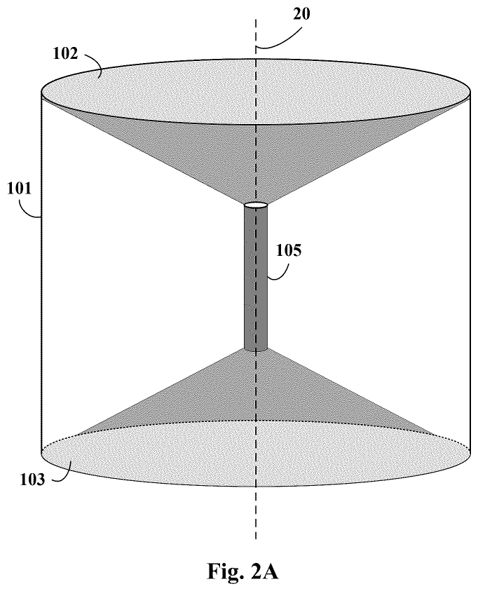

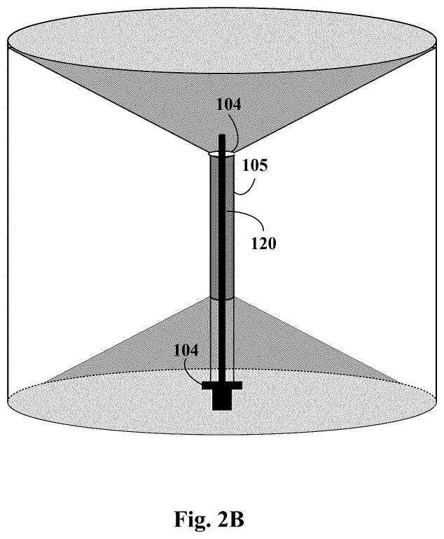

FIG. 1 shows an exemplary unitary lens antenna 100 comprising a radiofrequency (RF) cable 120, a cylindrical lens 101, and a top surface 102. The cylindrical lens 101 may be 3D printed, which is illustrated in FIG. 1 as having many printed layers the lens 101, as one embodiment. Moreover, the cylindrical lens 101 is printed having multiple cavities, which define the shape of biconical antenna. The size and shape of the antenna cavity may be scaled to optimize for different frequency ranges. For example, cavity related to the feed gap may be determined, for example, as having a length equal the wavelength divided by a constant (200, 300, etc. . . . ). In addition to the cylindrical lens 101 element, an RF cable 120 is coupled to the lens 101 and extends through the cylindrical lens 101, from the top surface 102 to the bottom surface 103 (see FIG. 2). The unitary lens antenna 100 may be used in any environment in which typical biconical antenna may be used.

The cylindrical lens 101 is a single, unitary structure that may comprise any plastic material capable of 3D printing with a dielectric constant of 6 or less. In one embodiment, the material may not have tangent losses of 0.007 or less. Furthermore, 3D printing allows for inexpensive, efficient manufacturing with the additional possibility of scaling the design to optimize for different frequency ranges. The unitary structure of the cylindrical lens 101 uniquely enables, among other benefits, this improved manufacturing efficiency. Multi-component antennas introduce significantly more complexity, which manifests with increased costs and reduced efficiency.

FIG. 2A shows an exemplary wireframe illustration of a cylindrical lens 101 comprising a biconical antenna cavity. The exemplary wireframe illustration comprises a cylindrical lens 101, a top surface 102, a bottom surface 103, cable interface 104, lens feed 105, and a centerline 20. The biconical antenna cavity is defined by the lens' top surface 102 and bottom surface 103 (see FIG. 2A). Both the top 102 and bottom surfaces 103 may be metalized or plated to form an antenna. Furthermore, the lens comprises a lens feed 105 having a diameter slightly larger than an RF cable 120, so that an RF cable may pass through from the top conical apex to the bottom conical apex. Moreover, a cable interface area 104 is a non-metalized area on the top surface 102 and bottom surface 103 adjacent to the lens feed. The cable interface area is non-metalized to avoid shorting.

The top surface 102 and bottom surface 103 define the geometry of a biconical antenna. These surfaces may also be referred to as the antenna surfaces. Typically, biconical antennas consist of two or more distinct pieces. The instant subject matter uses a single, unitary structure with a metalized top surface 102 and bottom surface 103, where each surface is metalized with a conductive paint. The appropriate thickness of the conductive paint is related to the frequency of operation. The formula for minimum thickness (δ) as a function of frequency (f), resistivity (ρ), magnetic permeability constant (μ₀), and material permeability (μₖ) is as follows:

$$δ = \sqrt{\frac{2 ρ}{2 π f {μ}_{k} {μ}_{0}}}$$

The minimum thickness of the metalized coating makes the top surface 102 and bottom surface 103 into an operable biconical antenna. In another embodiment, the top surface 102 and bottom surface 103 may be metal plated. Additionally, each of the top 102 and bottom surfaces 103 may be scaled to define geometries of antennas covering different bandwidths.

The lens feed 105 is a hollow channel that extends through the centerline of the lens. The lens feed 105 has a diameter larger than the diameter of the portion of the RF cable 120 being fed through the lens feed 105. The length of the lens feed 105 is determined by the geometry of the antenna surfaces and feed gap. The feed gap may be determined as a proportion of the intended detection frequency. Finally, the lens feed may electrically interface with the RF cable 120 which may include isolate the center conductor from the bottom surface 103 to the top surface 102.

FIG. 2B shows an exemplary wireframe illustration of a cylindrical lens 101 comprising the cable interface 104, lens feed 105 and RF cable 120. The RF cable 120 may further comprise comprises an outer jacket, located at the bottom of the cable. The RF cable 120 extends from its outer jacket, which protrudes from the bottom surface 103, passes through the lens feed 105, and continues past the top surface.

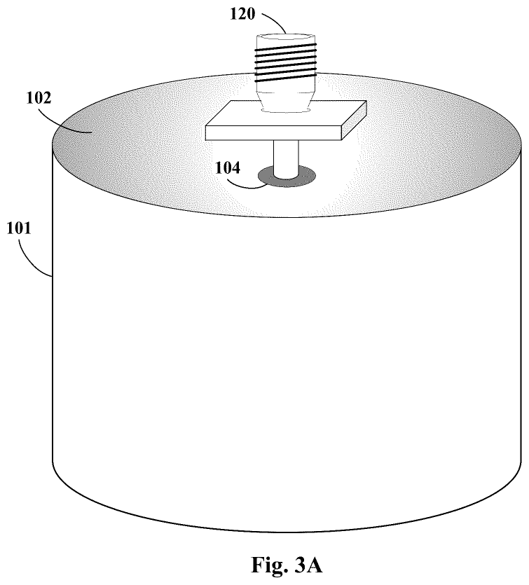

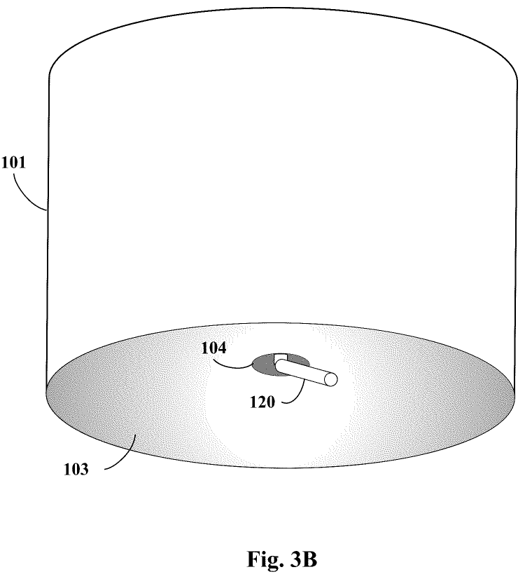

FIG. 3A shows an exemplary illustration a top surface 102 of a unitary lens antenna 100 comprising a lens 101, cable interface 104, and a RF Cable 120. Similarly, FIG. 3B shows an exemplary illustration a bottom surface 103 of a unitary lens antenna 100 comprising a lens 101, cable interface 104, and a RF Cable 120. The cable interface 104 provides electrical separation from the RF cable 120 and the metalized antenna surfaces to avoid shorting. The cable interface 104 is created by utilizing a liquid mask around the lens feed 105 before the antenna surfaces are metalized via conductive spray. Once the conductive spray dries, the liquid mask may be removed to expose the lens feed 105.

The RF cable 120 further comprises a center conductor, dielectric, and an outer conductor. The outer conductor is electrically isolated from the center conductor. The center conductor interfaces with the feed channel 105 to operable connected the top surface 102 and bottom surface 103. The lens feed may be electrically coupled to the inner conductor. In one embodiment, the RF cable comprises a coax cable connection, as illustrated in FIG. 3A. In one embodiment, the RF cable 120 is coupled to the lens 101 with a silver epoxy.

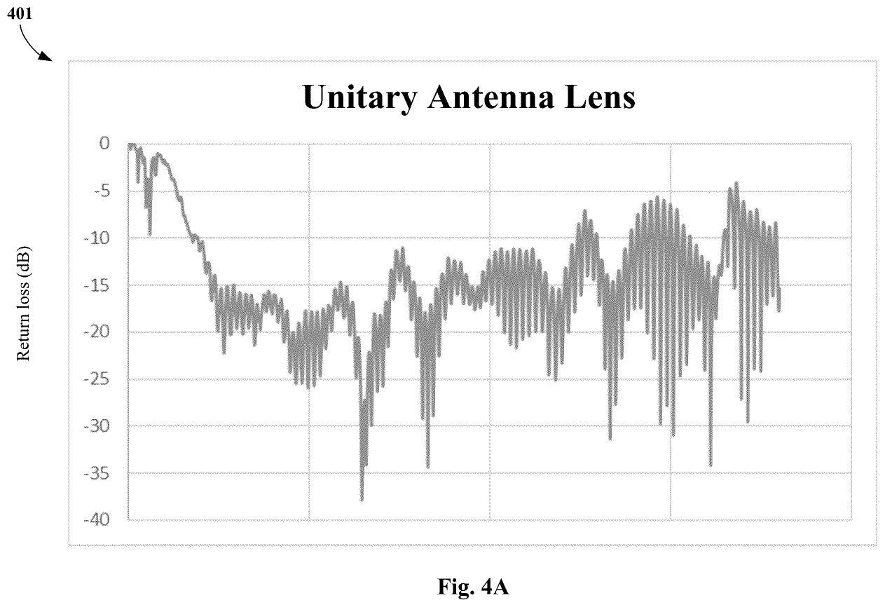

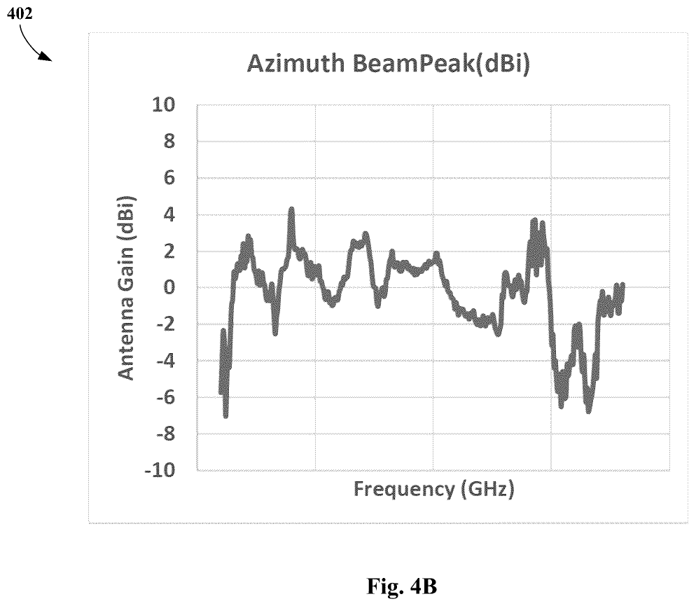

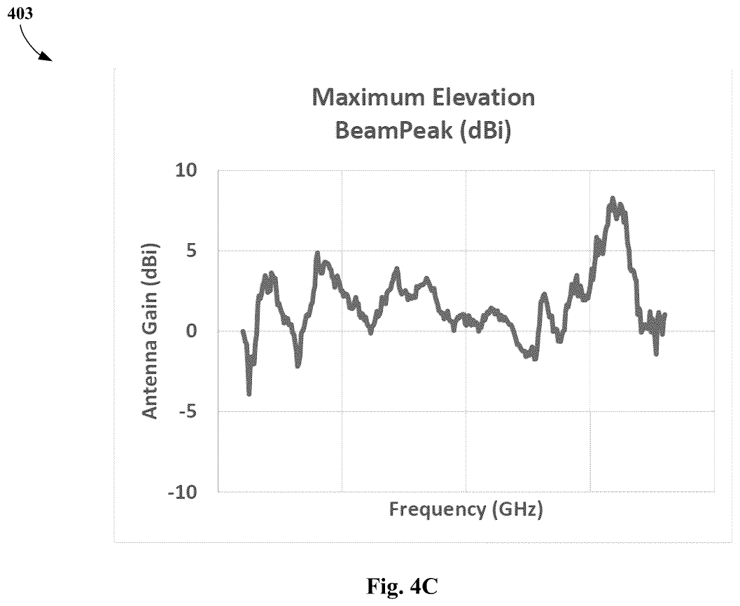

FIG. 4A graphically illustrates antenna return loss 401 of one embodiment of a unitary lens antenna 100. A −10 dB return loss depicts the antenna has approximately 90% efficiency. FIG. 4B graphically illustrates Azimuth Beam Peak (dBi) (Frequency vs. Antenna Gain) 402 of one embodiment of a unitary lens antenna 100. FIG. 4C graphically illustrates Maximum Elevation Beam Peak (dBi) 403 of one embodiment of a unitary lens antenna 100.

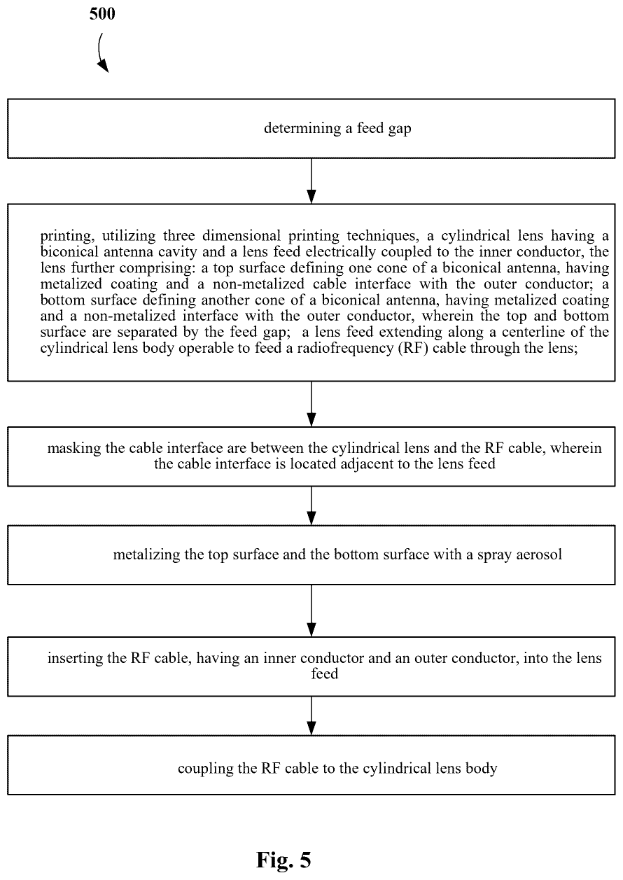

FIG. 5 is an exemplary block-diagram 500 of a method for producing a unitary lens antenna, obtained by the process of: determining a feed gap; printing, utilizing three dimensional printing techniques, a cylindrical lens having a biconical antenna cavity and a lens feed electrically coupled to the inner conductor, the lens further comprising: a top surface defining one cone of a biconical antenna, having metalized coating and a non-metalized cable interface with the outer conductor; a bottom surface defining another cone of a biconical antenna, having metalized coating and a non-metalized interface with the outer conductor, wherein the top and bottom surface are separated by the feed gap; a lens feed extending along a centerline of the cylindrical lens body operable to feed a radiofrequency (RF) cable through the lens; masking the cable interface are between the cylindrical lens and the RF cable, wherein the cable interface is located adjacent to the lens feed; metalizing the top surface and the bottom surface by applying an aerosol spray; inserting the RF cable, having an inner conductor and an outer conductor, into the lens feed; and coupling the RF cable to the cylindrical lens body.

In one embodiment, the aerosol spray comprises copper to metalize the surface and enable antenna capabilities. In another embodiment, the RF cable is coupled to or adhered to the cylindrical lens body with silver epoxy.

From the above description of Unitary Structure Lens Antenna, it is manifest that various techniques may be used for implementing the concepts of Unitary Structure Lens Antenna without departing from the scope of the claims. The described embodiments are to be considered in all respects as illustrative and not restrictive. The apparatus and product-by-process disclosed herein may be practiced in the absence of any element that is not specifically claimed and/or disclosed herein. It should also be understood that Unitary Structure Lens Antenna are not limited to the particular embodiments described herein, but is capable of many embodiments without departing from the scope of the claims.

What is claimed:

1. A unitary lens antenna, comprising:
a radiofrequency (RF) cable having an inner conductor and an outer conductor; and
a cylindrical lens having a biconical antenna cavity and a lens feed electrically coupled to the inner conductor, the lens further comprising:
a top surface defining one cone of the biconical antenna cavity, having a first metalized coating and a first non-metalized cable interface with the outer conductor;
a bottom surface defining another cone of the biconical antenna cavity, having a second metalized coating and a second non-metalized cable interface with the outer conductor; and
a lens feed extending along a centerline of the cylindrical lens body operable to feed the RF cable through the lens.

2. The unitary lens antenna of claim 1, wherein the cylindrical lens body is three-dimensionally printed.

3. The unitary lens antenna of claim 2, wherein the cylindrical lens further comprises a plastic material capable of 3D printing with a dielectric constant of 6 or less.

4. The unitary lens antenna of claim 2, wherein the cylindrical lens further a material not having tangent losses of 0.007 or less.

5. The unitary lens antenna of claim 1, wherein the coupling is accomplished by silver epoxy.

6. The unitary lens antenna of claim 1, wherein the metalized coating is applied via aerosol spray.

7. The unitary lens antenna of claim 4, wherein the aerosol spray comprises copper.

8. A method for producing a unitary lens antenna, obtained by the process of:
determining a feed gap;
printing, utilizing three dimensional printing techniques, a cylindrical lens having a biconical antenna cavity and a lens feed electrically coupled to the inner conductor, the lens further comprising:
a top surface defining one cone of a biconical antenna, having metalized coating and a non-metalized cable interface with the outer conductor;
a bottom surface defining another cone of a biconical antenna, having metalized coating and a second non-metalized interface with the outer conductor, wherein the top and bottom surface are separated by the feed gap;
a lens feed extending along a centerline of the cylindrical lens body operable to feed a radiofrequency (RF) cable through the lens;
masking the cable interface are between the cylindrical lens and the RF cable, wherein the cable interface is located adjacent to the lens feed;
metalizing the top surface and the bottom surface by applying an aerosol spray;
inserting the RF cable, having an inner conductor and an outer conductor, into the lens feed; and
coupling the RF cable to the cylindrical lens body.

9. The method for producing a unitary lens antenna of claim 8, wherein the aerosol spray comprises copper.

10. The method for producing a unitary lens antenna of claim 8, wherein coupling the RF cable to the cylindrical lens body comprises silver epoxy.

11. The method for producing a unitary lens antenna of claim 8, wherein the cylindrical lens further comprises a plastic material capable of 3D printing with a dielectric constant of 6 or less.

12. The method for producing a unitary lens antenna of claim 8, wherein the cylindrical lens further a material not having tangent losses of 0.007 or less.
